(19) United States
(12) Patent Application Publication
(10) Pub. No.: US 2023/0058163 A1
(43) Pub. Date: Feb. 23, 2023

(54) INFORMATION PROCESSING APPARATUS, PRODUCT DISPLAY SYSTEM, RECORDING MEDIUM, AND PRODUCT DISPLAY METHOD

(71) Applicant: CASIO COMPUTER CO., LTD., Tokyo (JP)

(72) Inventor: Yoshihiro TAKAYAMA, Tokyo (JP)

(73) Assignee: CASIO COMPUTER CO., LTD., Tokyo (JP)

(21) Appl. No.: 17/887,051

(22) Filed: Aug. 12, 2022

(30) Foreign Application Priority Data
Aug. 18, 2021 (JP) 2021-133577
Aug. 18, 2021 (JP) 2021-133578

(51) Int. Cl. G06Q 30/06

(52) U.S. Cl. CPC G06Q 30/0631

(57) ABSTRACT

A management server includes a processor configured to execute processing including: acquiring possession information indicating a product in possession owned by a user; specifying, among a plurality of products, the product in possession of the user corresponding to the possession information; and causing a display unit to display at least one selected from information relating to the plurality of products and information relating to the product in possession of the user that is specified, in a manner that allow recognition of a relationship between the plurality of products and the product in possession of the user that is specified.

### CROSS-REFERENCE TO RELATED APPLICATIONS

This application is based upon and claims the benefit of priority under 35 USC 119 of Japanese Patent Application Nos. 2021-133577 and 2021-133578, respectively filed on 18 Aug. 2021, the entire disclosure of which, including the description, claims, drawings, and abstract, are incorporated herein by reference in its entirety.

### BACKGROUND OF THE INVENTION

### Field of the Invention

The present disclosure relates to an information processing apparatus, a product display system, a recording medium and a product display method.

### Description of the Related Art

Conventionally, a technique of displaying products in a tree structure has been known. Japanese Unexamined Patent Application, Publication No. 2018-77724 describes this type of technique. Japanese Unexamined Patent Application, Publication No. 2018-77724 describes a technique including associating a product with a component belonging to a hierarchy immediately below among components constituting the product, and searching a component table in which a component constituting the product and an element belonging to a hierarchy immediately below among the elements constituting the component are associated, thereby creating a tree structure of components constituting the product for each hierarchy.

### BRIEF SUMMARY OF THE INVENTION

In order to achieve the above object, an information processing apparatus according to an aspect of the present disclosure is directed to an information processing apparatus including a processor configured to execute processing including: acquiring possession information indicating a product in possession owned by a user; specifying, among a plurality of products, the product in possession of the user corresponding to the possession information; and causing a display unit to display at least one selected from information relating to the plurality of products and information relating to the product in possession of the user that is specified, in a manner that allow recognition of a relationship between the plurality of products and the product in possession of the user that is specified.

### BRIEF DESCRIPTION OF THE SEVERAL VIEWS OF THE DRAWING

FIG. 1 is a schematic diagram showing a configuration of a product display system to which a management server according to an embodiment of the present disclosure is applied.

FIG. 2 is a block diagram showing a hardware configuration of the management server according to an embodiment of the present disclosure.

FIG. 3 is a functional diagram showing a functional configuration for executing product-in-possession specifying processing among the functional configurations of the management server shown in FIG. 2.

FIG. 4 is a block diagram showing a hardware configuration of a user terminal according to an embodiment of the present disclosure.

FIG. 5 is a functional block diagram showing a functional configuration for executing product display processing among the functional configurations of the user terminal shown in FIG. 4.

FIG. 6 is a schematic diagram showing a tree generation rule in a product display system according to an embodiment of the present disclosure by using an example of a tree structure.

FIG. 7 is a schematic diagram showing a tree display screen in a product display screen according to an embodiment of the present disclosure.

FIG. 8 is a schematic diagram showing an enlarged view of a part of the tree display screen shown in FIG. 7.

FIG. 9 is a schematic diagram showing a maximum enlargement screen obtained by further enlarging a part of the tree display screen shown in FIG. 8.

FIG. 10 is a schematic diagram for explaining a detailed product screen in the maximum enlargement screen shown in FIG. 9.

FIG. 11 is a schematic diagram showing data display indicating a category within which a user falls in the age distribution of purchasers of the product in the detailed product screen of FIG. 10.

FIG. 12 is a schematic diagram showing a possession status of an owner possessing the same product in the detailed product screen of FIG. 10.

FIG. 13 is a schematic diagram showing a screen when the screen shown in FIG. 9 is scrolled from the upper side to the lower side in the drawing.

FIG. 14 is a schematic diagram showing a tree display screen in a case of adding browsing history display to FIG. 7.

FIG. 15 is a schematic diagram showing a browsing progress rate display screen summarized for each model in FIG. 14.

FIG. 16 is a schematic diagram showing products arranged in time series in a sort display screen of the product display screen according to an embodiment of the present disclosure.

FIG. 17 is a schematic diagram showing products arranged in order of popularity in a sort display screen of the product display screen according to an embodiment of the present disclosure.

FIG. 18 is a schematic diagram showing products arranged in order of weight in a sort display screen of the product display screen according to an embodiment of the present disclosure.

FIG. 19 is a flowchart showing a flow of product-in-possession specifying processing executed by the management server of FIG. 2 having the functional configuration of FIG. 3.

FIG. 20 is a schematic diagram showing a model numbering rule in a product display system according to an embodiment of the present disclosure.

FIG. 21 is a flowchart showing a flow of automatic model numbering processing executed by the management server of FIG. 2 having the functional configuration of FIG. 3.

FIG. 22 is a schematic diagram showing a customized product displayed in tree display screen shown in FIG. 7.

FIG. 23 is a flowchart showing a flow of customized product displaying processing executed by the management server 10 of FIG. 2 having the functional configuration of FIG. 3.

### DETAILED DESCRIPTION OF THE INVENTION

Embodiments of the present disclosure will be described below with reference to the drawings.

### Product Display System

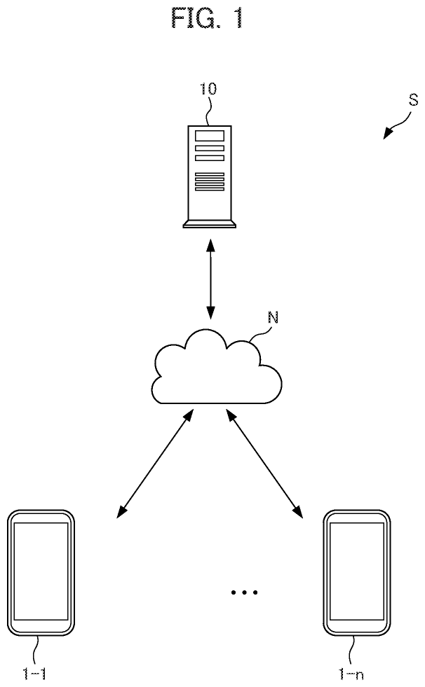

The outline of a product display system S will be described. FIG. 1 is a schematic diagram showing a configuration of the product display system S to which a management server 10 according to an embodiment of the present disclosure is applied. The system referred to herein may include not only an overall device configured from a plurality of devices, a plurality of means, and the like, but also a system including a single device.

As shown in FIG. 1, the product display system S according to the present embodiment includes a plurality of user terminals 1, a network N, and a management server 10. The management server 10 is connected to the plurality of user terminals 1 through the network N so as to be able to communicate with each other.

The network N may be realized by, for example, the Internet, a LAN (Local Area Network), or a network of cellular telephone networks, or a combination thereof.

The product display system S provides a product user with a product display screen for displaying a plurality of registered products. The product display system S is implemented by the management server 10. The management server 10 is, for example, a general-purpose computer capable of executing various functions by installing various programs. However, the present disclosure is not limited to this, and the management server 10 may be a computer incorporated in dedicated hardware. The management server 10 performs processing of generating and displaying a product display screen of a product based on the product information related to the product stored in the database. Details will be described later.

The user terminal 1 is a computer operated by a product user. The number of the user terminal 1 is not particularly limited, and n-number (n is any natural number) of user terminals 1 may be included in the product display system S. In the following description, without distinguishing the n-number of user terminals 1, the alphabet character at the end of the reference numeral is omitted, and is simply referred to as “user terminal 1”.

The user terminal 1 is, for example, a portable computer such as a smartphone or tablet. However, the present disclosure is not limited thereto, and the user terminal 1 may be a desktop type or a laptop type personal computer. Details will be described later.

### Management Server

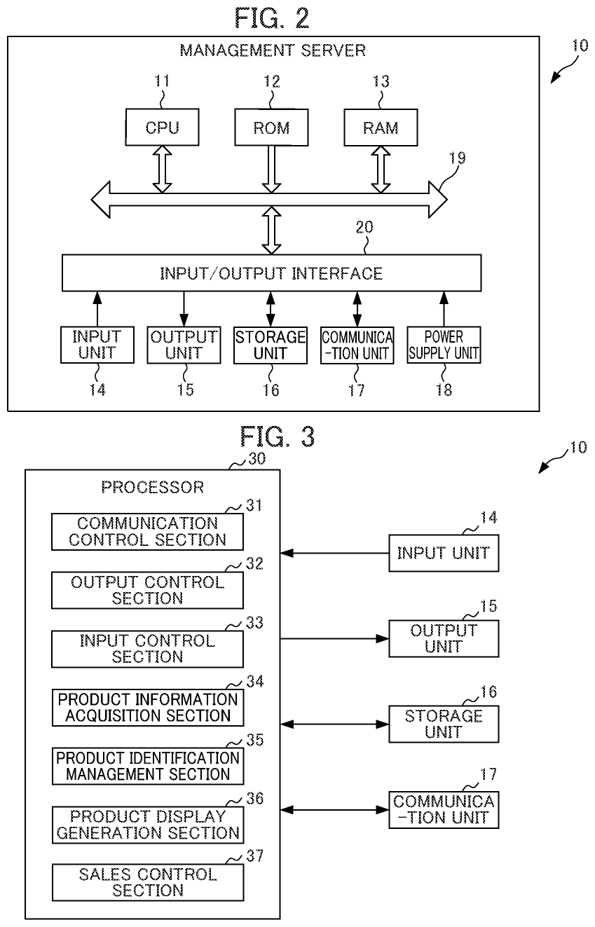

Next, an example of the management server 10 will be described. FIG. 2 is a block diagram showing a hardware configuration of the management server 10 according to an embodiment of the present disclosure.

As shown in FIG. 2, the management server 10 includes a CPU (Central Processing Unit) 11, ROM (Read Only Memory) 12, RAM (Random Access Memory) 13, an input unit 14, an output unit 15, a storage unit 16, a communication unit 17, a power supply unit 18, a bus 19, and an input/output interface 20.

The CPU 11 executes various kinds of processing according to programs recorded in the ROM 12 or programs loaded into the RAM 13 from the storage unit 16.

In the RAM 13, data required for the CPU 11 to perform various kinds of processing is also stored as appropriate.

The CPU 11, the ROM 12 and the RAM 13 are interconnected via the bus 19. The input/output interface 20 is also connected to the bus 19. The input unit 14, the output unit 15, the storage unit 16, the communication unit 17, and the power supply unit 18 are connected to the input/output interface 20.

The input unit 14 and the output unit 15 are user interfaces electrically connected to the input/output interface 20 in a wired or wireless manner. The input unit 14 includes, for example, a keyboard, a mouse, various buttons, a microphone, and the like, and inputs various kinds of information according to an instruction operation of the user. The output unit 15 includes, for example, a display for displaying an image, a speaker for amplifying voices, and the like, and outputs the image and the sound.

The storage unit 16 includes semiconductor memory such as DRAM (Dynamic Random Access Memory), and stores various data of the management server 10. The storage unit 16 is provided with a plurality of databases (not shown) for the product display system S. For example, the storage unit 16 is provided with a product database for storing a plurality of product information to be registered in the product display system S. Furthermore, the storage unit 16 includes, for example, a customized product database for storing a model number of a customized product which is a product customized by a user, and a corresponding model number table in which various specifications of the product and a model number corresponding to the specification in accordance with model numbering rule are inputted.

The communication unit 17 controls the communication performed by the CPU 11 to and from another device (not shown) via a network including the Internet.

The power supply unit 18 is connected to an external power source to supply power to each unit of the management server 10.

Next, the functional configuration of the management server 10 will be described. FIG. 3 is a functional diagram showing a functional configuration for executing product-in-possession specifying processing among the functional configurations of the management server 10 shown in FIG. 2. The product-in-possession specifying processing includes specifying a product in possession based on possession information indicating the product in possession owned by the user on the product display screen provided by the product display system S. The product-in-possession specifying processing will be described later. FIG. 3 is a functional block diagram showing a functional configuration for executing an automatic model numbering processing among the functional configurations of the management server 10 of FIG. 2. The automatic model numbering processing is a process that acquires customized product information, and automatically generates and assigns model numbers. The automatic model numbering processing will be described later.

The processor 30 for performing various types of control of the management server 10 is realized by the CPU 11 that executes arithmetic processing.

The processor 30 of the present embodiment includes a communication control section (communication control function) 31, an output control section (power control function) 32, an input control section (input control function) 33, a product information acquisition section (product information acquisition function) 34, a product identification management section (product identification management function) 35, a product display generation section (product display generating function) 36, and a sales control section (sales control function) 37.

The communication control section 31 executes processing for communicating with an external device through the communication unit 17. For example, the communication control section 31 executes processing for transmitting and receiving various kinds of information to and from the user terminal 1 connected to the management server 10 through the communication unit 17.

The output control section 32 executes processing for displaying an image on the screen of the output unit 15 of the management server 10. For example, the output control section 32 executes processing of displaying a management screen for managing the product display system S on the screen of the output unit 15.

The input control section 33 executes processing of accepting an operation of the input unit 14 by the user. For example, the input control section 33 executes processing of accepting an operation for managing the product display system S inputted by the user to the input unit 14 based on the information displayed on the screen of the output unit 15.

The product information acquisition section 34 executes processing of acquiring product information and customization information for the product display screen. The product information includes, for example, image information of a product, a brand name of a product, a sub brand name of a product, model number information as an identifier, and the like. Furthermore, the customization information indicates the specification of a customized product specified by the user. The customization information is, for example, a specification produced by modifying the specification of an existing product.

The product identification management section 35 performs, as a possession information specifying section, processing of identifying the product the user owns based on the model number of the product included in the possession information. For example, upon receiving a product-in-possession specifying processing command, the product identification management section 35 acquires the plurality of product information and the possession information included in the user information of the database in the storage unit 16, and identifies the product corresponding to the model number included in the possession information among the plurality of products. The product-in-possession specifying processing command is outputted when a product display generation section 36 described later executes processing of generating information for a product display screen. Furthermore, the product identification management section 35 functions as an identification information management section, and manages model numbers as the product identification information of the existing products stored in the product database in the storage unit 16. For example, when the input control section 33 receives the input operation of a model number of the new product at the input unit 14, the product identification management section 35 stores the model number in the product database in the storage unit 16. In addition, when performing the automatic model numbering processing, the product identification management section 35 generates a model number of a customized product that reflects the specification change of the customized product based on customization information acquired by the product information acquisition section 34. In other words, the processor 30 of the management server 10 acquires the customization information indicating the specification of the customized product for which the specification is set by the user, and generates a model number in which the specification of the customized product is based on the customization information. The model number and the automatic model numbering processing will be described later.

The product display generation section 36 performs processing of generating information for a product display screen. For example, when the communication control section 31 receives a generation command of the product display screen, the product display generation section 36 acquires the product information stored in the database in the storage unit 16, the identification information generated by the product identification management section 35, information relating to the tree generation rule, possession information specified by the product identification management section 35, etc., generates a product display screen based on these pieces of information, and causes the communication control unit 31 to transmit these pieces of information to the user terminal 1 via the communication unit 17. In other words, the product display control section 64 performs processing for causing the display unit to display at least one selected from information relating to a plurality of products and the specified product in possession of a user.

The product display screen according to the present embodiment includes, for example, a sort display screen in which the arrangement of products is determined based on information designated from among pieces of information relating to a plurality of products, and a tree display screen as a system diagram generated based on the information relating to the plurality of products. The information relating to the product includes information such as the specification of the product, the price of the product, and the number of favorite registrations from users. However, the present disclosure is not limited to these. The specification includes, for example, mechanical specifications such as color and shape of a wristwatch and design and shape of the belt, and functional specifications such as water resistance and automatic time correction of the watch. Detailed descriptions of the sort display screen and the tree display screen will be given later.

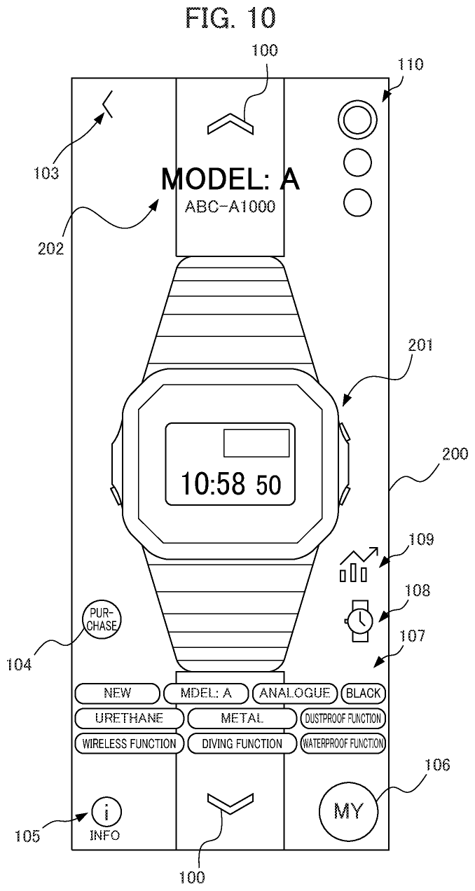

When a purchase target product is designated from among a plurality of products displayed in a list, the sales control section 37 executes processing of shifting to sales processing for purchasing the product. On the product display screen according to the present embodiment, when a displayed product is available for sale, a product purchase button 104 shown in FIG. 10 is displayed. For example, the sales control section 37 executes processing of instructing the product display generation section 36 to shift from the product display screen to an e-commerce site for selling products by pressing the purchase button 104 displayed on the product display screen. Furthermore, for a product that is no longer available due to the end of production or the like, a button for commenting a request for restoration or the like may be provided instead of the purchase button 104 to receive the request. However, the processing for purchasing is not limited to this and, for example, EC sites for purchasing may be displayed on the product display screen.

### User Terminal

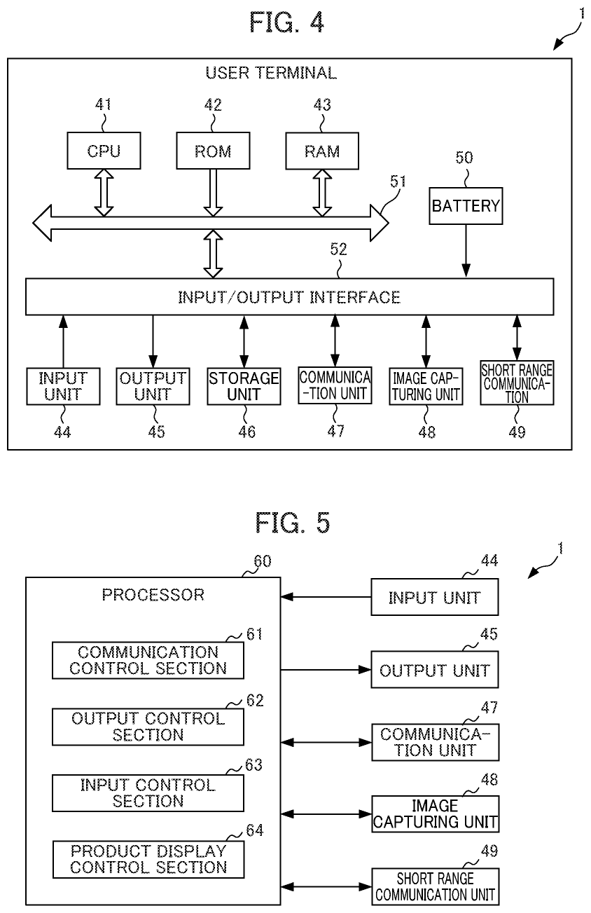

Next, an example of the user terminal 1 will be described. FIG. 4 is a block diagram showing a hardware configuration of the user terminal 1 according to an embodiment of the present disclosure.

The user terminal 1 of the present embodiment is, for example, a computer including a CPU 41, ROM 42, RAM 43, an input unit 44, an output unit 45, a storage unit 46, a communication unit 47, an image capturing unit 48 as an imaging unit, a short range communication unit 49, a battery 50, a bus 51, and an input/output interface 52. The common or similar configurations as described above may be denoted with the same names, and the detailed descriptions thereof may be omitted.

The input unit 44, the output unit 45, the storage unit 46, the communication unit 47, the image capturing unit 48, the short range communication unit 49, and the battery 50 are connected to the input/output interface 52.

The image capturing unit 48 (not shown) includes, for example, an optical lens unit and an image sensor. In order to photograph a subject, the optical lens unit includes a lens such as a focus lens for condensing light and a zoom lens. The focus lens is a lens for forming an image of a subject on the light receiving surface of the image sensor. The zoom lens is a lens that causes the focal length to freely change in a certain range. The optical lens unit also includes peripheral circuits to adjust setting parameters such as focus, exposure, white balance, and the like, as necessary.

The image sensor is configured by an optoelectronic conversion device, an AFE (Analog Front End), and the like. The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e., captures) the image of the subject, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is outputted as an output signal from the image capturing unit 48. Such an output signal of the image capturing unit 48 is hereinafter referred to as “image information”. The image information is supplied to the CPU 11, an image processing unit (not illustrated), and the like as appropriate.

The short range communication unit 49 is a second communication unit that performs radio communication at a short distance. The short range communication unit 49, for example, performs communication in a communication method based on a communication standard such as BLE (Bluetooth (registered trademark) Low Energy), Wi-Fi (Wireless Fidelity), NFC (Near Field Communication), or the like. Furthermore, the short range communication unit 49 can perform communication by bringing an IC tag having a predetermined IC chip embedded therein close thereto. For example, by storing the product information in the IC chip in advance, the short range communication unit 49 can read the product information in the vicinity of the IC tag.

The battery 50 supplies power to the user terminal 1. For example, the battery 50 includes a lithium ion battery. When the user terminal 1 is a desktop personal computer, the user terminal 1 has, for example, a power supply unit that can supply power to the user terminal 1 by being connected to an external power source instead of the battery 50.

Next, a functional configuration of the user terminal 1 will be described. FIG. 5 is a functional diagram showing a part of the functional configuration of the user terminal 1 according to an embodiment of the present disclosure. A processor 60 for performing various controls of the user terminal 1 is realized by the CPU 41 that executes the arithmetic processing. The processor 60 of the present embodiment includes a communication control section 61, an output control section 62, an input control section 63, and the product display control section 64.

The communication control section 61 executes processing for communicating with an external device through the communication unit 47. For example, the communication control section 61 executes processing for transmitting and receiving various kinds of information to and from the management server 10 through the communication unit 47.

The output control section 62 executes processing for displaying an image on a screen of the output unit 45 of the user terminal 1. For example, the output control section 62 executes processing of displaying a product display screen received by the communication control section 61 through the communication unit 47 on the screen of the output unit 45.

The input control section 63 executes processing of accepting an operation of the input unit 44 by the user. For example, the input control section 63 performs processing of accepting an entry operation for the possession information. The possession information is, for example, information related to a product in possession of the user inputted to the input unit 44 by the user based on the information displayed on the screen of the output unit 45.

The product display control section 64 performs various kinds of processing for the product display screen. The various kinds of processing for the product display screen include, for example, product display processing, possession information input processing, and the like. When the input control section 63 receives an input of starting the product display processing of the user to the input unit 44, the product display control section 64 executes processing for starting the product display process and processing for transmitting a command for generating a product display screen to the management server 10 through the communication unit 47 in response to the command to the communication control section 61. Furthermore, when the communication control section 61 receives the information for generating the product display screen from the management server 10 via the communication unit 47, the product display control section 64 executes processing of instructing the output control section 62 and outputting the product display screen to the screen of the output unit 45.

Furthermore, when the input control section 63 receives the input operation of the possession information by the user to the input unit 44, the product display control section 64 starts the possession information input processing, and executes processing of instructing the communication control section 61 and transmitting to the management server 10 the possession information and the possession information input command to the database via the communication unit 47. Furthermore, when the input control section 63 receives the input operation of the customization information by the user to the input unit 44, the product display control section 64 starts the customization information input processing, and executes processing of instructing the communication control section 61 and transmitting to the management server 10 the customization information and the possession information input command to the database via the communication unit 47. In the present embodiment, the product display control section 64 instructs the output control section 62 to display a guidance screen for guiding the input of customization information on the screen of the output unit 45, and prompts the user to input the specifications of the product. The guidance screen is a screen on which options such as setting of shape and color of parts of a wristwatch body, a belt, and the like, setting of a box to be packaged, setting of a nickname, and the like are displayed. When the selection of the option of the guidance screen by the operation to the user input unit 44 is accepted by the input control section 63, the product display control section 64 instructs the communication control section 61 to transmit the customization information including the specification of the selected customized product to the management server 10 via the communication unit 47. In the present embodiment, the product display control section 64 transmits the customization information each time a single option is selected and a specification is inputted. However, the present disclosure is not limited to this. For example, the product display control section 64 may transmit the customization information when all of the options are selected.

In the product display system S according to the present embodiment, the user terminal 1 includes the product display control section 64 and displays the product display screen by the processing of the product display control section 64. However, the user terminal 1 may not include the product display control section 64. In this case, the user terminal 1 can display the product display screen on the screen of the output unit 45 by accessing a product display screen website provided in the management server 10 through the communication unit 47.

The user terminal 1 according to the present embodiment acquires the possession information by the user's input operation to the input unit 44 in the user terminal 1. However, the present disclosure is not limited to this. For example, the user terminal 1 may acquire the possession information as an identifier by causing the image capturing unit 48 to read a bar code such as a QR code (registered trademark) including the possession information. Alternatively, the user terminal 1 may acquire the possession information by reading the possession information from the IC tag including the possession information by short-range communication as wireless communication by the short range communication unit 49 of the user terminal 1 as an external device. Furthermore, the user terminal 1 may acquire the possession information by directly capturing an image of a product by the image capturing unit 48 and analyzing the captured image. In this case, the processor 30 of the user terminal 1 may perform processing of acquiring the possession information using a learning model (AI: Artificial Intelligence) learned by machine-learning or the like. Furthermore, the user terminal 1 may acquire the image information of the user's product in possession and perform image recognition on the image information, thereby specifying the product-in-possession and acquiring the possession information.

Next, the product display screen provided by the product display system S according to the present embodiment will be described. In the product display system S according to the present embodiment, the product display screen can be switched between the tree display screen and the sort display screen. The tree display screen is a mode of the product display screen. The tree display screen is, for example, a screen displayed by arranging products in a tree-structured manner in accordance with a tree generation rule. The sort display screen is a mode of the product display screen. The sort display screen is, for example, a screen displayed by arranging products in an arrangement determined based on the information designated from among the information relating to the product information. The modes of the product display screen are not limited thereto, and may be a part thereof or may include another mode of the screen display.

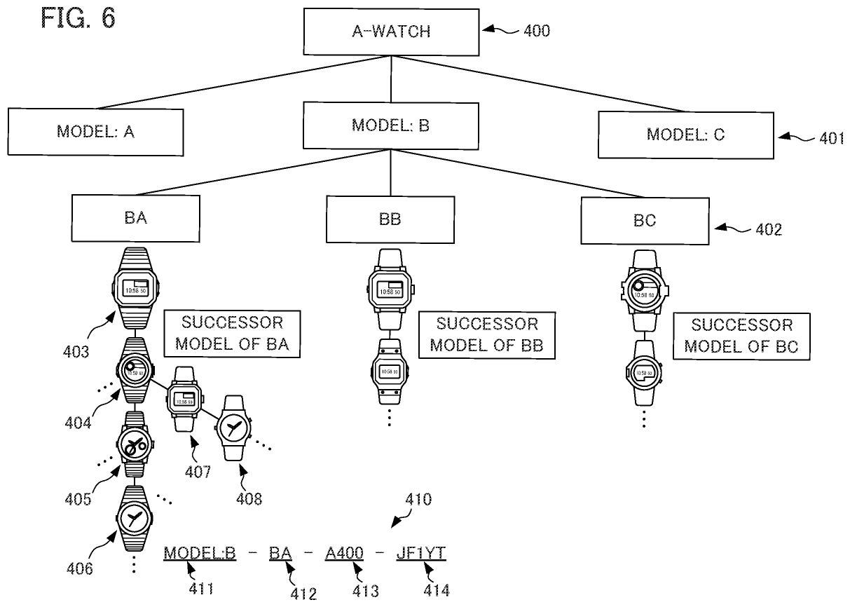

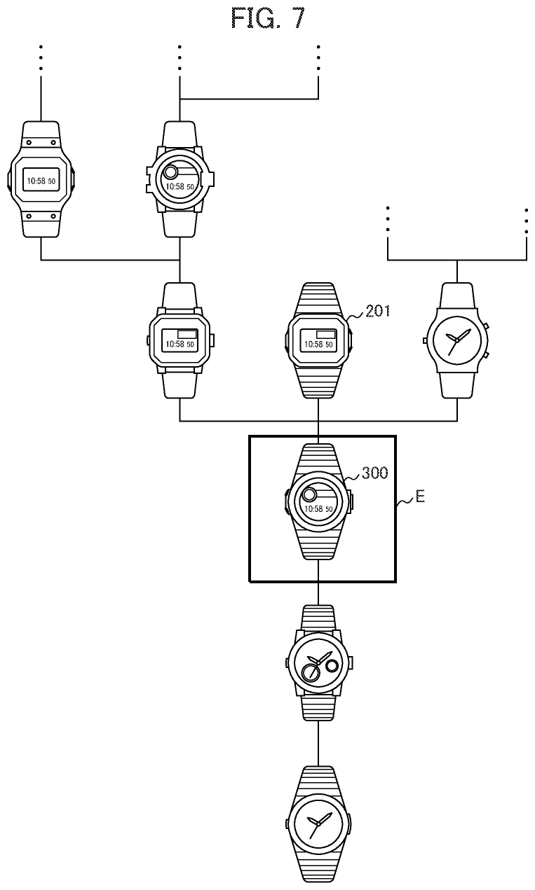

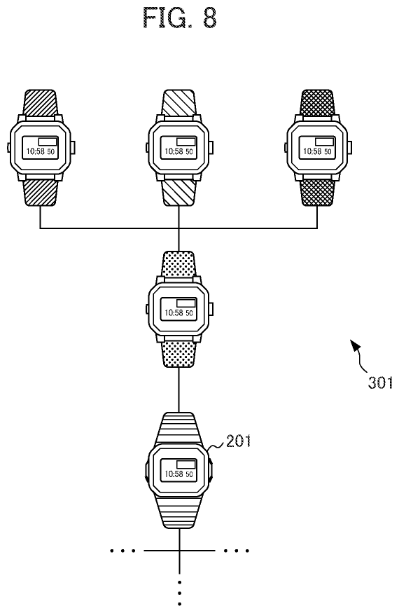

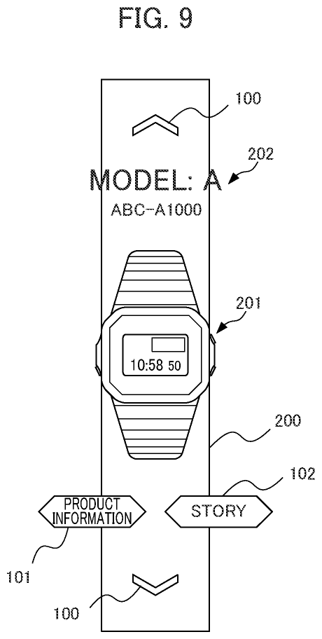

First, the tree display screen will be described with reference to FIGS. 6 to 13. FIG. 6 is a schematic diagram showing a tree generation rule in the product display system S according to an embodiment of the present disclosure by using an example of a tree structure. FIG. 7 is a schematic diagram showing a tree display screen in a product display screen according to an embodiment of the present disclosure. FIG. 8 is a schematic diagram showing a tree display screen in which a part of the tree display screen shown in FIG. 7 is enlarged. FIG. 9 is a schematic view showing a maximum enlargement screen obtained by further enlarging a part of the tree display screen shown in FIG. 8.

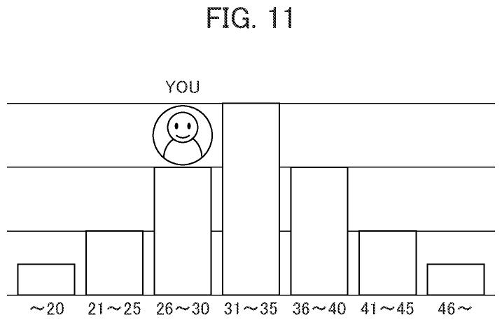

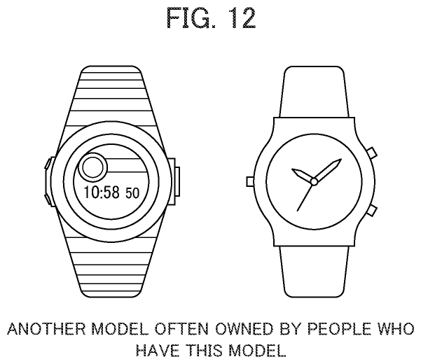

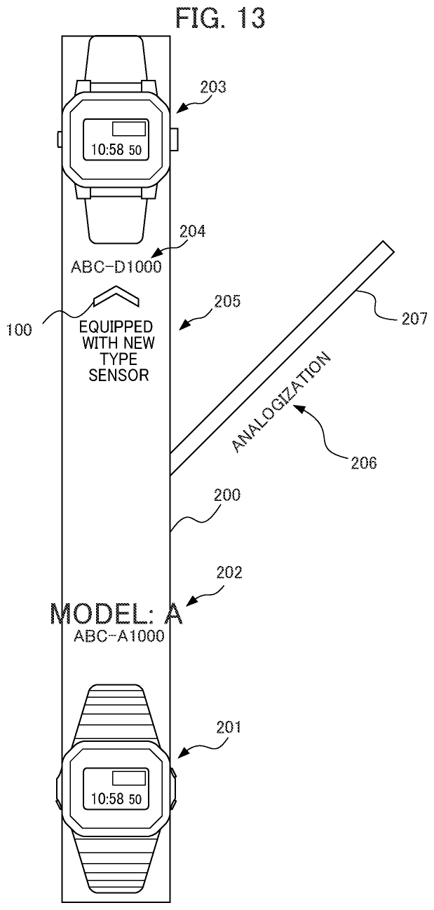

FIG. 10 is a schematic diagram for explaining a detailed product screen in the maximum enlargement screen shown in FIG. 9. FIG. 11 is a schematic diagram showing a screen in which a category within which a user falls is indicated according to the age of the user on the age distribution of purchasers of the product displayed on the detailed product screen of FIG. 10. FIG. 12 is a schematic diagram showing a screen on which the possession status of the owner of the same model is displayed on the detailed product screen of FIG. 10. FIG. 13 is a schematic view showing a screen in which the maximum enlargement screen shown in FIG. 9 is displayed when the maximum enlargement screen is scrolled from the upper side to the lower side in the drawing. The screens described below with reference to FIGS. 7 to 13 are examples of a product display screen, and the configuration of the screens is not limited thereto.

First, the tree structure will be described with reference to FIG. 6. In the product display system S according to the present embodiment, data of a wristwatch as an example of a product can be stored in the storage unit 16 so that the data structure thereof has a tree structure, and a tree display screen as a system diagram can be generated in the form of a tree structure. Although a wristwatch is used as an example of a product in the present embodiment, the product is not limited to a wristwatch, and may be another product such as a calculator, a musical instrument, an electronic dictionary, or the like.

In the database of the storage unit 16 of the management server 10 according to the present embodiment, a plurality of main brands of a wristwatch are stored in a tree structure. In the example shown in FIG. 6, the tree structure branches downward from the main brand 400 as a top to subordinate hierarchical levels such as a sub brand 401, a series 402, etc. For example, when the main brand is “A-WATCH”, the sub brands of “A-WATCH” are “MODEL: A”, “MODEL: B”, and “MODEL: C”, and the series of “MODEL: B” are “BA”, “BB”, and “BC”, and the tree structure having the main brand 400 as the top branches down to the lower hierarchical levels such as the sub brand 401 and the series 402 as shown in FIG. 6.

In addition, the arrangement of products in the series is arranged with the early model first, followed by successor models. For example, in the example shown in FIG. 6, after the early model 403, successor models 404, 405, and 406 are arranged in this order. In addition, when there is a derived model with the product of the series 402, the derived model is connected diagonally to the product of the series 402. For example, in the example shown in FIG. 6, derived models 407 and 408 are disposed diagonally to the successor model 404.

When displaying the tree display screen, the management server 10 according to the present embodiment extracts information such as brands, sub brands, and series from the product information stored in the storage unit 16 in the form of a tree structure, and specifies the position of the product arrangement in the tree structure based on the information. In the present embodiment, the product information is acquired from, for example, a model number. In other words, each of the pieces of the product information includes a plurality of pieces of information relating to the specification of the product. Furthermore, in the example of the model number 410 of the successor model 406 shown in FIG. 6, a sub brand model number 411 as a first identifier, a series model number 412 as a second identifier, and a successor model number 413 as a third identifier are acquired as the product information. In the present embodiment, the model number as an identifier includes a sub brand model number 411 as a first identifier, a series model number 412 as a second identifier, and a successor model number 413 as a third identifier. The hierarchy of the tree structures is not limited to this, and can be freely set according to the purpose.

Therefore, in the tree generation rule according to the present embodiment, for each of a plurality of products in the tree structure, the information such as a model number included in the product information is checked in order from the top, and the corresponding branch destination is specified to determine the arrangement on tree display screen. For example, in the present embodiment, brands, sub brands, series, successor models, and derived models are ranked in this order, and the branch destination is specified by confirming the information in this order to determine the arrangement. In addition, even when a new product is added to the product database of the storage unit 16 in accordance with the tree generation rule, the product display generation section 36 according to the present embodiment can execute processing of generating and outputting a tree display screen by specifying a position for the new product in the tree structure.

The tree generation rule in this case, for example, generates a new sub brand and causes the new sub brand to branch from the main brand based on a sub brand model number when the sub brand model number of the product whose arrangement is to be specified is new. That is, each of the pieces of the product information includes the sub brand model number 411 indicating a sub brand associated with a predetermined brand, and the product display generation section 36 performs processing of generating information related to display in which a plurality of products are divided for each sub brand from the product information including the sub brand model number 411 corresponding to the predetermined brand. In addition, the product display generation section 36 of the management server 10 according to the present embodiment generates a product display screen based on information relating to the generated display.

The product display generation section 36 also generates a new series and causes the new series to branch from the sub brand based on a series model number when the series model number of the product whose arrangement is to be specified is new. That is, each of the pieces of the product information includes the series model number 412 indicating a series associated with a predetermined sub brand, and the product display generation section 36 generates information related to display in which a plurality of products are divided into series based on the product information including the series model number 412 corresponding to a predetermined sub brand.

In addition, for the products whose arrangement are to be specified, the product display generation section 36 determines the arrangement of the products in each of the series based on successor model number included in the product information in accordance with tree generation rule. That is, the product display generation section 36 arranges the products on the axis line of the series in order of the early model on the product display screen. In other words, each of the pieces of the product information includes the successor model number 413 indicating a successor model of a product associated with a predetermined series, and the product display generation section 36 generates information relating to display indicating a state linking the successor model after the product associated with the predetermined series based on the product information including the successor model number 413 corresponding to the product associated with the predetermined series. Furthermore, when the information indicating a derived model is included in the product information whose arrangement is to be specified, the product display generation section 36 specifies the product of the model of the derivation source, and generates a new derived model and causes the new derived model to branch from the product of the model of the derivation source. The tree generation rule is not limited to this.

As specific processing in the management server 10, when the product information is acquired, the product display generation section 36 recognizes, based on the product information, the main brand name, the sub brand name, the acronym of model number, the numeric value of model number, and the end of model number, separately. For example, in the example of FIG. 6, the main brand is recognized as A-WATCH, the sub brand name is recognized as MODEL: B, the acronym of the model number is recognized as BA, the numeric value of the model number is recognized as 100, and the end of the model number is recognized as JF1YT.

Based on the recognized information including the main brand name, the sub brand name, the acronym of the model number, the numerical value of the model number, and the end of the model number, the product display generation section 36 performs processing of specifying and arranging the product information on the tree structure as described above, in accordance with the tree generation rule. In the product display system S according to the present embodiment, as described above, the product information such as a model number assigned to one model is classified into four categories including sub brand, acronym of the model number, numeric value of the model number, and end of the model number, whereby the tree display screen is automatically generated based on the tree structure in which the product information is arranged in an appropriate position corresponding to each of the four categories.

That is, the processor 30 of the management server 10 according to the present embodiment performs processing of generating the tree display screen of a plurality of products based on the product information. Here, the processing of generating the tree display screen performed by the processor 30 may be processing of generating the tree display screen, or processing of generating information such as the product information and meta data required for generating the tree display screen by the processor 60 of the user terminal 1 and transmitting such information to the user terminal 1.

The generated tree display screen is transmitted to the user terminal 1 through the communication unit 17. As described above, the product display generation section 36 performs the processing of generating the product display screen based on the product information acquired in accordance with the tree generation rule.

Next, the tree display screen of the product display screen in the product display system S according to the present embodiment will be described with reference to FIG. 7. When the product display screen is acquired from the management server 10, the user terminal 1 outputs a tree display screen on the screen of the output unit 45 as shown in FIG. 7. In the example in FIG. 7, a tree display screen of one of a plurality of series is displayed. Four wristwatches lined up from the lower side to the upper side in the middle in the figure are wristwatches of the same series. Furthermore, the wristwatches branching from the fourth wristwatch from the bottom to right and left are each a derived model of the fourth wristwatch from the bottom. Therefore, in the product display system S according to the present embodiment, by switching the product display screen to the tree display screen, the user can easily grasp the relationships of the respective products.

Furthermore, in the product display system S according to the present embodiment, it is difficult to display all the products at a time in the most reduced tree display screen because the number of products is large. Therefore, in the product display system S according to the present embodiment, not all products are displayed, but only representative models are displayed. In the product display system S according to the present embodiment, the management server 10 can enlarge or reduce the product display screen in response to a command from the user terminal 1. The product display screen shown in FIG. 7 is the most reduced tree display screen.

The representative model is, for example, a representative model defined as a base model by a manufacturer providing the products. In other words, a derived model which partially changed the specification such as color or material of the base model is not a representative model. Therefore, these displays are omitted in a full display screen or the like. In addition, the product display system S according to the present embodiment can specify a product in possession which is a product owned by a user from among the plurality of pieces of product information as described above, and can display the specified product in possession as a representative model.

Next, when the product display screen shown in FIG. 7 is enlarged, a tree display screen shown in FIG. 8 is obtained. More specifically, FIG. 8 is an enlarged view of the vicinity of the wristwatch shown by the product image 201 in FIG. 7. With the tree display screen enlarged, in FIG. 8, a derived model group 301 of the four wristwatches which are not displayed in the tree display screen of FIG. 7 is displayed.

Next, when the product display screen shown in FIG. 8 is further enlarged, a tree display screen shown in FIG. 9 is obtained. FIG. 9 shows a most enlarged tree display screen. The tree display screen may display one axis line 200 on which the product image 201 is displayed. Furthermore, white arrows 100 are displayed at the upper and lower portions of the axis line 200. The tree display screen can be slid upward or downward by clicking or tapping either of the white arrows 100, or by dragging or swiping the tree display screen upward or downward.

In this tree display screen, the product image 201 and a display 202 such as a model number or the like are displayed above the product image 201, and a product information button 101 and a story button 102 are displayed below the product image 201. The story button 102 is a button for moving to the screen in which information about the development story of the product is described by pressing the story button 102, for example. The information on the development story of a product is, for example, information on a developer's commitment, an episode at the time of development, a development secret, and the like. When the product information button 101 is pressed, a detailed product screen in which the product information shown in FIG. 10 is displayed in more detail is displayed, for example.

In the detailed product screen, a left arrow button 103 is displayed on the upper left of the screen. In the product display system S, when the arrow button 103 is pressed, the tree display screen shown in FIG. 9 appears. In addition, there is a color change button 110 at the upper right of the screen. The color change button 110 is a button for switching the color variation of the displayed product image. In the detailed product screen of the example of FIG. 10, there are three color change buttons 110 corresponding to three colors, respectively, and the product image is switched to the color corresponding to the color change button 110 by pressing the color change button 110. One of the color change buttons 110 is a double circle indicating that a color corresponding to the one color change button 110 has been selected.

Furthermore, in the detailed product screen, the upper and lower two data display buttons 108 and 109 are displayed on the right side in the middle of the screen. In the product display system S, when the above data display button 109 is pressed, the screen shifts to a data display screen as shown in FIG. 11. FIG. 11 is a schematic view of a data display screen showing a category within which the user falls in the age distribution of purchasers of the product shown in FIG. 10. The data is generated based on the user information stored in the database of the storage unit 16 in advance.

In the product display system S, when the lower data display button 108 is pressed, the screen shifts to a data display screen as shown in FIG. 12. FIG. 12 is a schematic view of a data display screen showing the possession status of another product owned by the purchaser of the same product in the detailed product screen of the drawing. The data display screen displays another product owned by the purchaser of the product displayed in FIG. 10, and can suggest another product to the user.

In the detailed product screen shown in FIG. 10, a purchase button 104 is displayed on the left side in the middle of the screen. In the product display system S, when the purchase button 104 is pressed as described above, the sales control section 37 executes processing of shifting to sales processing for purchasing a product, and shifts from the detailed product screen to the e-commerce site screen.

A tag group 107 including a plurality of tags indicating the characteristics of the displayed model is displayed immediately below the product image 201. For example, in FIG. 10, tags such as “NEW” indicating that the model is the latest model, “MODEL: A” indicating the main model name, “Analog” indicating that the model is an analog model, and “Black” indicating the color of the product are displayed. When a tag among the tags in the tag group 107 is pressed on the detailed product screen of FIG. 10, the management server 10 of the product display system S according to the present embodiment can search for a product on the condition associated with the tag. Furthermore, the management server 10 performs processing of displaying the searched product information on the product display screen. In this case, the mode of the product display screen may be a tree display screen, a sort display screen, or any other type of display screen.

The processor 30 of the management server 10 according to the present embodiment may generate, in the sort display screen, information related to a display in which a plurality of products are divided for each sub brand from the product information including the sub brand model number 411 corresponding to a predetermined brand. Furthermore, the processor 30 of the management server 10 according to the present embodiment may generate information on the display in which a plurality of products are divided for each series based on the product information including the series model number 412 corresponding to the sub brand. Furthermore, the processor 30 of the management server 10 according to the present embodiment may generate information relating to display indicating a state linking the successor model after the product associated with the series based on the product information including the successor model number 413 corresponding to the product associated with the predetermined series.

An INFO button 105 for displaying an item specification is displayed at the lower left of the detailed product screen of FIG. 10. In the product display system S, when the INFO button 105 is pressed, processing is performed of shifting to a screen on which a detailed specification of a product is displayed. Furthermore, a MY button 106 for displaying a product in possession registered in advance is displayed in the lower right of the screen. In the product display system S, when the MY button 106 is pressed, the processing of shifting to the detailed product screen of the user's product in possession is performed.

Here, the tree display screen shown in FIG. 9 will be described again. As described above, the screen can be slid by a user's operation. The tree display screen shown in FIG. 13 is a diagram when the tree display screen shown in FIG. 9 is slid upward. In the tree display screen shown in FIG. 13, the product image 201 shown in FIG. 9 is displayed on the lower side, and the display 202 such as a model number is displayed immediately above the product image 201.

At the upper portion of the tree display screen, another model of the product image 203 is displayed. A display 204 such as a model number or the like is displayed below the product image 203. Below the display 204, a message 205 of “equipped with new type sensor” is displayed with the white arrow 100 interposed therebetween. The message 205 is disposed between the product image 201 and the product image 203, and the content of the message 205 can attract the user's interest such as the features of the product set ahead of the axis line 200. That is, the processor 30 of the management server 10 according to the present embodiment sets text information to be displayed between the products in the tree display screen.

Furthermore, an axis line 207 extending from the right side in the middle of the axis line 200 to the upper right is displayed. Below the axis line 207, there is displayed a message 206 of “Analogization”. The content of the message 206 includes content that can attract the user's interest, such as, for example, the features of the product set ahead of the axis line 207. That is, the management server 10 of the product display system S according to the present embodiment can set text information displayed between the products in the tree display screen. Furthermore, the text information includes, for example, contents that can provide easy understanding in the relationship between products while subtracting the user's interest.

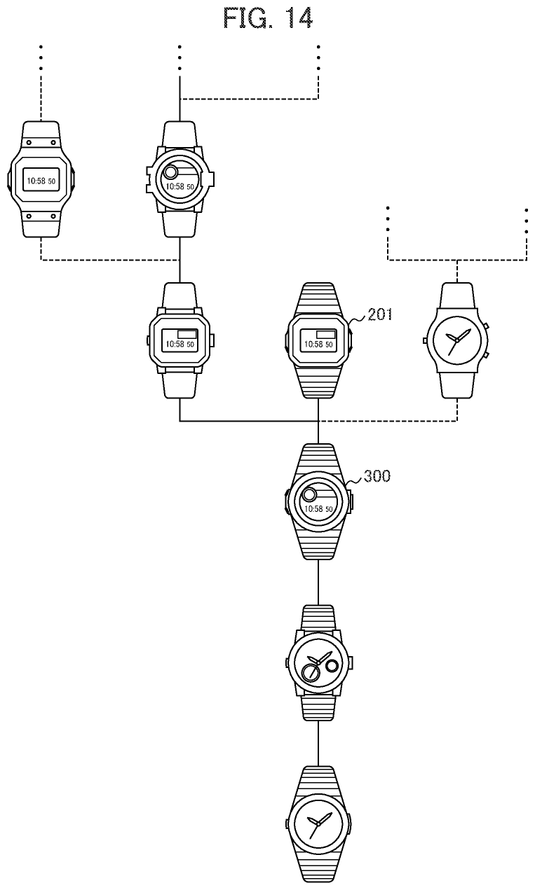

Furthermore, in the product display system S according to the present embodiment, browsing history information can be acquired, and display of the axis line is changed according to the presence or absence of the browsing history information as shown in FIG. 14. For example, in the example of FIG. 14, for the product display screen in FIG. 7, the tree display screen is such that the axis line is a solid line when there is a browsing history, and the axis line is a broken line when there is no browsing history. The display mode of the axis line is not limited to this. With such a configuration, the user can immediately determine a product that has not yet been browsed and, therefore, the labor of searching for the product is omitted.

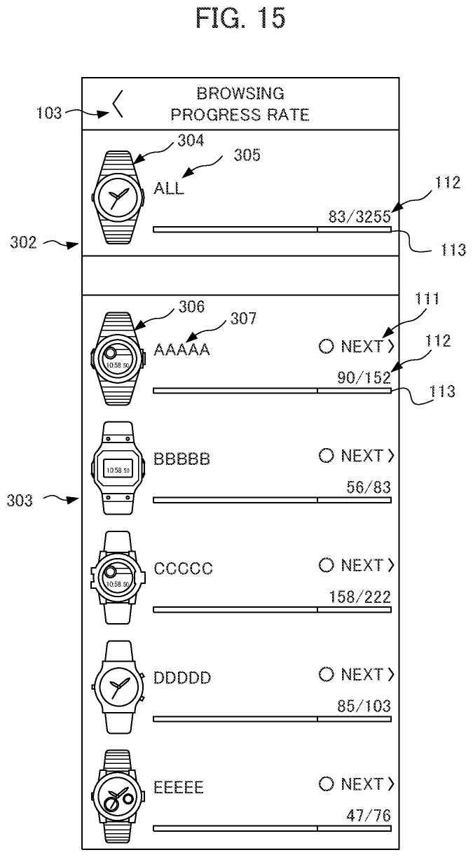

Furthermore, in the product display system S according to the present embodiment, a browsing progress rate display screen can be displayed as shown in FIG. 15. The browsing progress rate is a numerical value indicating the ratio of the browsed products calculated based on the browsing history information. In the browsing progress rate display screen, the browsing progress rate is displayed for a selection element selected by the user among the elements in the tree structure such as the main brand, the sub brand, and the series. In the example of FIG. 15, “All” is selected as the selection element.

“All” means all products included in a predetermined brand.

In addition, in the browsing progress rate display screen according to the present embodiment, in addition to the browsing progress rate of the selection element, individual browsing progress rates of the respective subordinate elements in the hierarchy immediately below in the tree structure of the selection element are also displayed. In the case of FIG. 15, “AAAAA”, “BBBBB”, “CCCCC”, “DDDDD”, and “EEEEE”, which are a plurality of sub brands of a hierarchical level immediately below a predetermined brand, are displayed as subordinate elements. Furthermore, in the browsing progress rate display screen according to the present embodiment, as shown in FIG. 15, a display 302 in which the browsing progress rate of the selection element is displayed is displayed above the screen, and a display 303 in which the browsing progress rate of the subordinate element is displayed individually is displayed below the display 302.

The display 302 displays a product image 304, a selection element name display 305, a bar 113, and a browsing progress rate 112 from the left side of the screen. In the product image 304, an image of a product representing the selection element is displayed. The display 305 displays the name of the selection element. The bar 113 is set so that the color changes according to the number of browsing, the browsing progress rate 112, and the browsing progress rate. The browsing progress rate 112 displays the number of products included in the selection element and the number of products that have been browsed out of the products included in the selection element. In the example of FIG. 15, it is shown that 83 types of products have already been browsed out of 3255 types of products.

In the display 303 of FIG. 15, display of the browsing progress rate of each sub brand of the subordinate element has the same configuration as display of the browsing progress rate of the selection element in the display 302. In the following description, display of the sub brand “AAAAA” will be described as representing display of the browsing progress rate of the sub brand as a subordinate element. In display of the browsing progress rate of the sub brand “AAAAA”, a product image 306, a display 307 of a subordinate element name, a bar 113, a “next” button 111, and a browsing progress rate 112 are displayed from the left side.

In the product image 306, an image of a product representing the sub brand “AAAAA” is displayed. In the display 307, the name “AAAAA” of the sub brand is displayed. Since the bar 113 and the browsing progress rate 112 have the same configuration as that of the display 302, their descriptions are omitted. Furthermore, when the “Next” button 111 is pressed, the browsing progress rate screen shifts to the browsing progress rate screen when “AAAAA” is selected as the selection element.

For example, when the “Next” button 111 for display of the browsing progress rate of the brand “AAAAA” is pressed in FIG. 15, the browsing progress rate screen shifts to the browsing display screen when the brand “AAAAA” is selected. The whole element selected by the browsing progress rate display screen of the configuration can be compared with the element of the hierarchy immediately below the element, whereby it is possible for the user to obtain more detailed information on the browsing progress rate.

As described above, the product display screen according to the present embodiment is switchable to the browsing progress rate display screen, whereby it is possible for the user to easily grasp the browsing state of the product display screen. The screen described with reference to FIGS. 14 and 15 is an example of a screen relating to the browsing history, and the configuration of the screen is not limited to this.

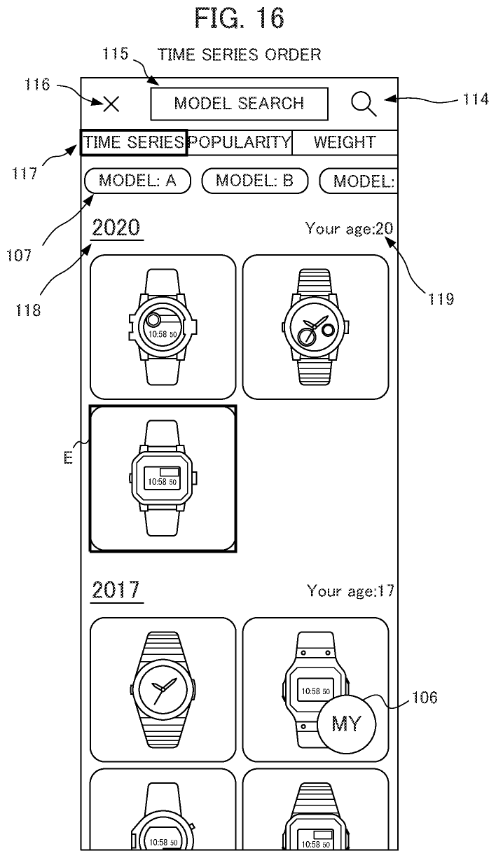

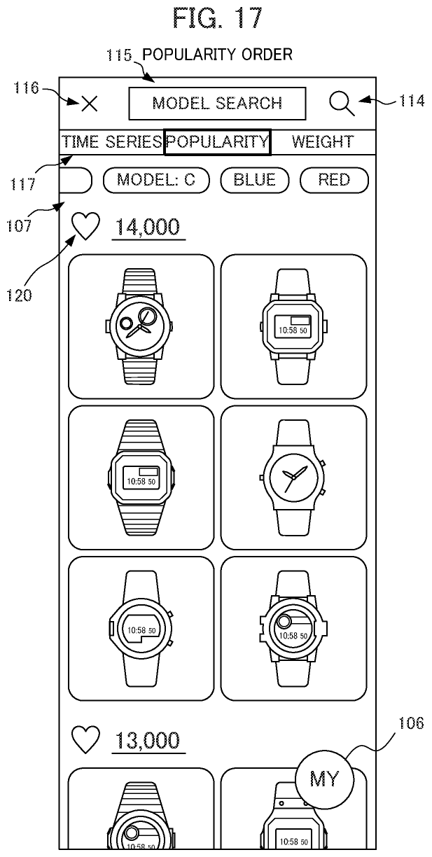

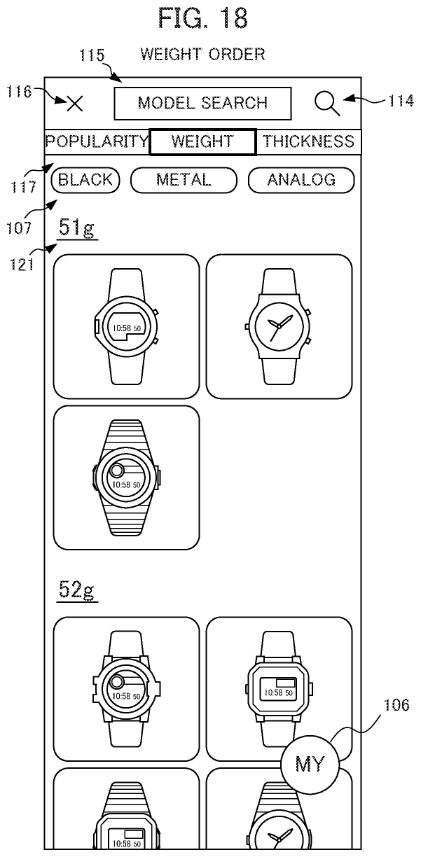

Next, the sort display screen will be described with reference to FIGS. 16 to 18. FIG. 16 is a schematic diagram showing products arranged in time series in a sort display screen of the product display screen according to an embodiment of the present disclosure. FIG. 17 is a schematic diagram showing products arranged in order of popularity in a sort display screen of the product display screen according to an embodiment of the present disclosure. FIG. 18 is a schematic diagram showing products arranged in order of weight in a sort display screen of the product display screen according to an embodiment of the present disclosure.

The sort display screen is a product display screen displayed by determining the arrangement of a plurality of products based on information designated from among pieces of information related to the product information. For example, in FIG. 16, the product display system S displays a product display screen in which the arrangement of the products is determined based on the time-series information included in the product information.

In the sort display screen shown in FIG. 16, an x button 116 for closing the window is displayed at the upper left of the drawing. Furthermore, there is a search icon 114 at the upper right in the drawing, and when the search icon 114 is pressed while a search word is inputted to an input box 115, only the products corresponding to the search word can be displayed. Below the X button 116, the input box 115, and the search icon 114, there is a display 117 in which a part of the condition field in which a plurality of conditions including the “time series”, “popularity”, “weight”, “number of registrations”, “thickness”, and “price” are displayed is displayed, and the condition field that is not displayed can be displayed by sliding the condition field. Also, the condition field of the designated information is highlighted. For example, in the example of FIG. 16, the frame of the field is highlighted by displaying a thick line as information for which the condition field of “time series” is designated.

Furthermore, below the display 117, a tag group 107 that includes a plurality of tags indicative of product features is displayed. The tag group 107 can be slid to the left and right. The tags include, for example, “sub brand name,” “series name,” “color variation,” “function,” “display type,” and the like. Furthermore, below the tag group 107, a display 118 of the year and a display 119 of the age of the user are displayed. Below the display 118, a product image corresponding to the year indicated by the display 118 is displayed. Furthermore, the display 119 is a display indicating the age of the user in the year of the display 118. The age displayed on the display 119 is automatically calculated from the year of the display 118 and the age information of the user registered in advance in the database of the storage unit 16 of the management server 10. In the display 119, the user can compare the history of the product with his or her history, for example.

In the lower right of the product display screen, the MY button 106 is displayed. In the product display system S, when the MY button 106 is pressed, the process of scrolling to the screen where the product in possession is displayed in the sort display screen is executed.

On the product display screen according to the present embodiment, when the above-mentioned condition field is selected, the arrangement of products is changed based on the contents described in the condition field. For example, when the condition field of “popularity” is selected as the designated information as shown in FIG. 17, a display 120 of the number of favorites is displayed instead of the display 118 of the year in FIG. 16, and the products are organized and displayed in accordance with the number of favorites. In the product display system S according to the present embodiment, the product information includes the number of favorite registrations totaled for each product. When the condition field of “weight” is selected as the designated information as shown in FIG. 18, a weight display 121 is displayed instead of the year display 118 in FIG. 16, and the products are organized and displayed in accordance with the weight of the products. The descriptions using FIGS. 16 to 18 are examples of the sort display screen, and the configuration of the screens is not limited thereto.

Furthermore, in the product display system S according to the present embodiment, the possession information including information such as a model number of a product in possession can be stored in advance in the database of the storage unit 16 of the management server 10. In addition, the management server 10 according to the present embodiment can change and highlight display of the product specified based on the possession information stored in the database on the product display screen. In other words, the processor 30 of the management server 10 performs processing for displaying the relationship between the plurality of products and the specified product in possession of the user in a recognizable manner on the screen of the output unit 45 of the user terminal 1.

For example, on the product display screen of the tree display screen of FIG. 7, when the image of the product specified based on possession information is the product image 300, the product image 300 is highlighted by being surrounded by a thick frame E. In this case, the tree display screen of FIG. 7 is a mode of a product display screen that allows for the recognition of the relationship between a plurality of products and a product in possession of the user. Furthermore, the highlighting method may be a method of changing display of the product image 300 itself. For example, the highlighting method may be a method of changing the size or color of the product image 300 or an animation with motion.

In the product display system S according to the present embodiment, in the product corresponding to the product in possession, the edge of the product image is surrounded by a thick frame E and emphasized as shown in FIG. 16. Therefore, the visibility of the product in possession is improved, and the user can more easily search for the product in possession. In addition, as a representative model displayed when the display is reduced in the tree display screen, a product associated with the possession information can be displayed instead of the base model set by the manufacturer of the product. In addition, the processor 30 sets the appearance image of the product corresponding to the product in possession among the plurality of products arranged in the tree display screen, to the appearance image that matches the specification of the possession information.

On the product display screen according to the present embodiment, only display of the product images corresponding to the product in possession is changed as a mode in which the relationship between the plurality of products and the product in possession of the user can be recognized. However, the present disclosure is not limited thereto. For example, the product display screen may change only display of product images of a plurality of products other than a product in possession to distinguish between the plurality of products and the product in possession of the user to recognize the relationship therebetween, or may change display of both the product in possession and existing products to distinguish between the plurality of products and the product in possession of the user to recognize the relationship therebetween. Furthermore, the mode of a product display screen capable of recognizing the relationship between the plurality of products and the product in possession of the user is not limited to the tree display screen, and may be, for example, the sort display screen.

That is, in the product display system S according to the present embodiment, the processor 30 performs processing for acquiring the possession information indicating a product in possession owned by the user, specifying the product in possession of the user corresponding to the possession information from among the plurality of products, and displaying at least one selected from the information relating to the plurality of products and the information relating to the specified product in possession of the user on the screen of the output unit 45 of the user terminal 1 as the display unit in such a manner that the relationship between the plurality of products and the specified product in possession of the user can be recognized.

Here, the display unit is a screen of the output unit 45 of the user terminal 1 in the present embodiment. However, the present disclosure is not limited to this, and the display unit may be a screen of the output unit 15 of the management server 10, for example. Furthermore, the processing for displaying on the display unit may be processing of generating a screen of the mode displayed on the screen of the output unit 45 of the user terminal 1, or processing of generating the possession information or the product information for generating a screen of the mode by the user terminal 1.

Next, the product-in-possession specifying processing will be described with reference to flowcharts. The product-in-possession specifying processing refers to a series of processing for identifying a product owned by a user among a plurality of products stored in a database of the storage unit 16 of the management server 10.

When executing the product-in-possession specifying processing, as shown in FIG. 3, in the CPU 11, the product information acquisition section 34, the product identification management section 35, and the product display generation section 36 function. A database is set in one area of the storage unit 16 as described above. Multiple pieces of product information are stored in the database.

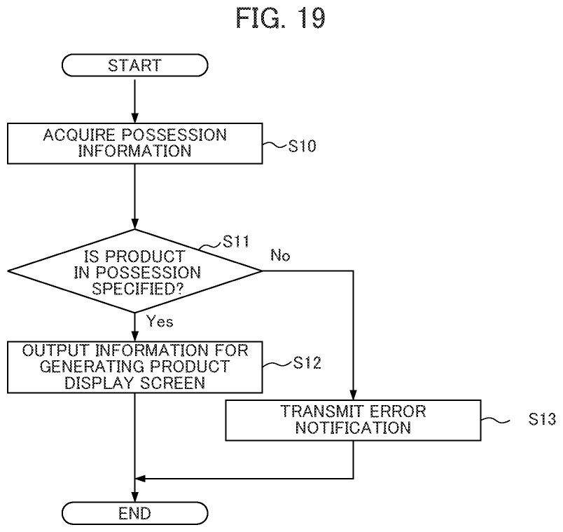

FIG. 19 is a flowchart showing a flow of the product-in-possession specifying processing executed by the management server 10 of FIG. 2 having the functional configuration of FIG. 3. The product-in-possession specifying processing starts at a timing when the communication control section 31 receives possession information of a product in possession from the user terminal 1 through the communication unit 17.

First, the processor 30 acquires the possession information of the product-in-possession from the user terminal 1 via the communication unit 17 (Step S10). Next, the processor 30 refers to the plurality of products stored in the database of the storage unit 16 and determines whether there is a product corresponding to the product in possession (Step S11). If there is no product corresponding to the product in possession (Step S11: NO), the processor 30 transmits an error notification to the user terminal 1 via the communication unit 17 (step S13), and ends the processing. If there is a product corresponding to the product in possession, the processor 30 specifies the product as a product in possession (Step S11: YES), transmits information for product display screen generation including the product information of the product in possession to the user terminal 1 via the communication unit 17 (Step S12), and ends the processing.

The management server 10 configured as described above includes the processor 30 configured to perform the processing of acquiring the possession information indicating a product in possession owned by a user, specifying the product in possession of the user corresponding to possession information from among a plurality of products, and displays at least one selected from the information relating to the plurality of products and the information relating to the specified product in possession of the user on the display unit in a manner that allow recognition of the relationship between the plurality of products and the specified product in possession of the user.

With such a configuration, the management server 10 according to the present embodiment can be automatically reflected on the product display screen by acquiring the product in possession of the user. Therefore, it is possible for the user to recognize and distinguish the relationship between the plurality of products and the product in possession of the user by referring to the generated product display screen, and it is possible to more easily retrieve the product in possession of the user from the product display screen.

Furthermore, in the management server 10 according to the present embodiment, each product information includes a plurality of pieces of information relating to the products, and the processor 30 determines the arrangement of the plurality of products to be displayed based on the information designated from among the plurality of pieces of information relating to the products.

With such a configuration, the management server 10 can automatically sort the plurality of products by designating the information, and thus can provide more efficient browsing of the plurality of products.

Furthermore, in the management server 10 according to the present embodiment, each product information includes a plurality of pieces of information relating to products, and the processor 30 executes processing for generating a tree display screen of a plurality of products based on the product information.

With such a configuration, the management server 10 can generate the tree display screen automatically by acquiring the product information, and can create the tree display screen more efficiently.

Furthermore, the processor 30 of the management server 10 according to the present embodiment sets text information to be displayed between the products in the tree display screen.

With such a configuration, the management server 10 can more easily grasp the product information on the tree display screen by setting the text information such as relationships and semantics between the products in the tree display screen.

Furthermore, in the management server 10 according to the present embodiment, respective pieces of the product information include the sub brand model number 411 indicating a sub brand associated with a predetermined brand, and the processor 30 performs processing for generating information related to a display in which a plurality of products are divided for each sub brand based on the product information including the sub brand model number 411.

With such a configuration, in the management server 10 according to the present embodiment, it is possible to recognize the sub brand based on the model number, generate a product display screen in which a plurality of products are automatically divided for each sub brand, and create a product display screen more conveniently.

Furthermore, in the management server 10 according to the present embodiment, respective pieces of the product information include the series model number 412 indicating a series associated with a predetermined sub brand, and the processor 30 performs processing for generating information related to display in which a plurality of products are divided for each series based on the product information including the series model number 412 corresponding to the predetermined sub brand.

Thus, in the management server 10 according to the present embodiment, it is possible to recognize a series of products based on the model number, generate a product display screen in which a plurality of products are automatically divided for each series, and create the product display screen more conveniently.

Furthermore, in the management server 10 according to the present embodiment, respective pieces of the product information include the successor model number 413 indicating a successor model of a product associated with a predetermined series, and the processor 30 performs processing for generating information relating to display indicating a state linking the successor model after the product associated with the predetermined series based on the product information including the successor model number 413.

With such a configuration, in the management server 10 according to the present embodiment, it is possible to generate the product display screen in which the products are arranged in the order of development of the series automatically based on the model number, and create the product display screen more conveniently.

Furthermore, the processor 30 of the management server 10 according to the present embodiment sets the appearance image of the product corresponding to the product in possession among the plurality of products to the appearance image that matches the specification of the possession information.

With such a configuration, it is possible for the user to more easily find the product in possession on the product display screen.

When a purchase target product is designated from among a plurality of products displayed in a list, the processor 30 of the management server 10 according to the present embodiment shifts to sales processing for purchasing the product.

With such a configuration, it is possible for the user to buy products while watching the product display screen, leading to a further improvement in convenience.

Furthermore, the processor 30 of the management server 10 according to the present embodiment is configured to acquire the possession information based on information manually inputted by the user, acquire the possession information by the image capturing unit 48 reading an identifier, acquire the possession information by receiving information from an external device such as an IC tag or the like by short-range radio communication, or acquire the possession information by analyzing an image of a product in possession captured by the image capturing unit 48.

With such a configuration, it is possible for the user to easily generate the possession information by, for example, performing an input operation to the input unit 44 of the user terminal 1. Furthermore, it is possible for the user to more easily acquire the possession information by causing the image capturing unit 48 to read the QR code (registered trademark) or the like. Furthermore, it is possible for the user to more easily acquire the possession information by causing the short range communication unit 49 of the user terminal 1 to communicate with the IC tag or the like in a short distance.

Furthermore, since the image of the product in possession captured by image capturing unit 48 of the user terminal 1 is transmitted to the management server 10, and the processor 30 analyzes the image and acquires possession information, it is possible for the user to cause the processor 30 to more conveniently acquire the possession information.

Furthermore, in the product display system S according to the present embodiment, it is possible to determine a display position for a customized product designated by a user on the product display screen based on its model number, and add the customized product to the target of display.

The customized product will be described. The customized product is a product for which the specification is set by a user. For example, the specification of a customized product is set by the user modifying the specification of an existing product. Furthermore, the specification of the customized product may be selected and set not only from the specifications of the existing product, but also from the specifications not included in the existing product. A customized product may be created by the user in the product display system S, or a customized product may be created by another system or retailer.

It is possible for the product display system S according to the present embodiment to acquire from the user the customization information including related information such as the specification of a customized product and the order area, and execute, based on the customized product, the automatic model numbering processing of generating a model number of the customized product. The customization information is generated by a dedicated application program owned by a product display screen website of the management server 10 or the user terminal 1.

The method of acquiring the customization information is not limited to these methods. For example, the customization information may be acquired from identification information such as a QR code (registered trademark) printed on a seal attached to a product at a dealer or the like by the image capturing unit 48 of the user terminal 1, or identification information such as a QR code (registered trademark) displayed on a screen of an output unit of the product. Alternatively, the customization information may be acquired by performing the image processing on the products imaged by the image capturing unit 48 of the user terminal 1.

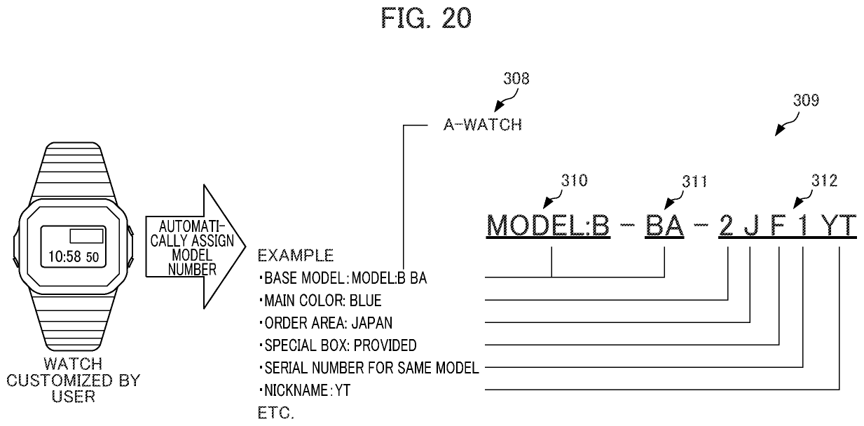

In the product display system S according to the present embodiment, the model number includes characters indicating the specification of the product as shown in FIG. 20, and thus it is possible to recognize the specification information included in the customization information of the customized product, and generate the model number of the customized product based on the specification information according to the model numbering rule. In other words, the processor 30 of the management server 10 according to the present embodiment acquires the customization information indicating the specification of the customized product for which the specification is set by the user, and generates the model number of the customized product in which the specification of the customized product is based on the customization information.

Next, based on the model number generated by the automatic model numbering processing, the processor 30 of the management server 10 according to the present embodiment performs processing of displaying at least one selected from the existing product and the customized product on the screen of the output unit 45 of the user terminal 1. In the present embodiment, the processor 30 performs processing of generating a product display screen in which existing products and customized products are displayed in a listed manner on the screen of the output unit 45 of the user terminal 1. Here, when displaying on the screen, the processor 30 determines the display position of the existing product based on the model number set in the existing product, and determines the display position of the customized product based on the model number of the customized product. Next, the processor 30 performs processing of generating a product display screen based on the determined display position.

Next, the model numbering rule will be described with reference to FIG. 20. FIG. 20 is a schematic diagram for explaining the model numbering rule in the product display system S according to an embodiment of the present disclosure by using a specific customized product. In the product display system S according to the present embodiment, the model number of the product is generated in accordance with the model numbering rule. The model numbering rule defines how the model number is set up. By the model numbering rule, the model number is set up by regularly arranging characters and numbers indicating the specification of the product, and characters and numbers indicating information related to the product other than the specification of the product.

For example, as shown in FIG. 20, a model number 309 includes a sub brand model number 310 indicating a sub brand of the product, a series model number 311 indicating a series of the product, and characters 312 indicating related information related to the product other than the specification of the product. The characters 312 each have a meaning of related information, and each indicate a main color, order area, the presence or absence of a special box, a serial number when a model of the same specification has already been registered, a nickname set by the user, and the like, in order from the left of the figure. As described above, the characters 312 are each set to a numeric value, a character, or the like, which indicates a specification that can be selected by the user at the time of customization. The numeric values and characters set in the specification are not limited to the example of FIG. 20.

Furthermore, as shown in FIG. 20, since the management server 10 according to the present embodiment stores, in the storage unit 16, the sub brand “MODEL: B” or the series “BA” shown in the model number 309 in association with the “A-WATCH” 308 of the main brand, the main brand can be identified from the sub brand model number or the series model number. Therefore, in the management server 10 according to the present exemplary embodiment, it is possible to acquire the information of the specification of the product and the related information from the model number generated in accordance with the model numbering rule, and it is possible to generate the screen of the product display screen based on the information.

Furthermore, when the specification of the customized product included in the customization information is acquired, the management server 10 according to the present embodiment can generate a model number of the customized product according to the model numbering rule, and will be specifically described below with reference to the example of FIG. 20.

The storage unit 16 of the management server 10 according to the present embodiment stores a corresponding model number table in which various specifications related to the product and model number corresponding to the specification are inputted according to the model numbering rule. The product identification management section 35 of the management server 10 compares the specification information of the product acquired from the user terminal 1 with the corresponding model number table, and sets a model number corresponding to the specification. In the example of FIG. 20, when the communication control section 31 acquires the product specification that the main color of the product is “blue” from the user terminal 1 through the communication unit 17, the product identification management section 35 of the management server 10 compares the main color “blue” with the corresponding model number table, and sets “2” as a model number of the specification acquired by specifying the corresponding model number.

Similarly, when the information of the specification that the order area is Japan is acquired, the product identification management section 35 sets the model number of the specification acquired by specifying the corresponding model number “J”. When acquiring the information of the specification with the setting of the special box, the product identification management section 35 specifies the corresponding model number “F” and sets it as the model number of the acquired specification. In addition, when a customized product having the same specification has already been stored in the database of the customized products, the product identification management section 35 specifies the serial number and set it as a model number of the acquired specification. Furthermore, when the setting information of the nickname “YT” is acquired, the product identification management section 35 sets it as a model number of the customized product.

Furthermore, the product identification management section 35 of the management server 10 according to the present embodiment refers to the corresponding model number table when setting a model number corresponding to the specification of the acquired customization information. However, the present disclosure is not limited to this. For example, when the specification of the customized product included in the customization information is acquired from the user terminal 1, the product identification management section 35 of the management server 10 may refer to the product registered in the product database of the storage unit 16 and set a model number of the product having the same specification as a model number of the customized product.

Furthermore, the product identification management section 35 of the management server 10 may automatically set a model number corresponding to the product specification customized by the AI processing when the machine learning processing using the relationship between the specifications and the model numbers of the existing products as training data is performed in advance, and the specification of the customized product included in the customization information is acquired from the user terminal 1.

As described above, the management server 10 according to the present embodiment receives and acquires the customization information transmitted from the user terminal 1 as described above. In the present embodiment, the customization information is acquired at each timing at which each of the various specifications is determined by the user in the user terminal 1. That is, in the present embodiment, each time the user determines one of the specifications in the user terminal 1, the management server 10 acquires the customization information including the specification from the user terminal 1 and sets a model number corresponding to the specification in comparison with the corresponding model number table.

However, as described above, the user terminal 1 may transmit the customization information including all specifications to the management server 10 at a timing when all specifications of the customized products are inputted. In this case, the management server 10 sets model numbers corresponding to all the specifications included in the acquired customization information at one time.

In any of the cases, the processor 30 of the management server 10 according to the present embodiment can acquire the customization information including information related to products other than the specification, and generate a model number of the customized product in which the related information is reflected together with the specification change.

Next, automatic model numbering processing will be described. The automatic model numbering processing refers to a series of processing for generating and outputting a model number for the customization information acquired from the user in accordance with a model numbering rule stored in a database of the storage unit 16 of the management server 10.

When executing the automatic model numbering processing, as shown in FIG. 3, in the CPU 11, the product information acquisition section 34, the product identification management section 35, and the product display generation section 36 function. Furthermore, the database is set in one area of the storage unit 16 as described above. The database stores data for multiple products.

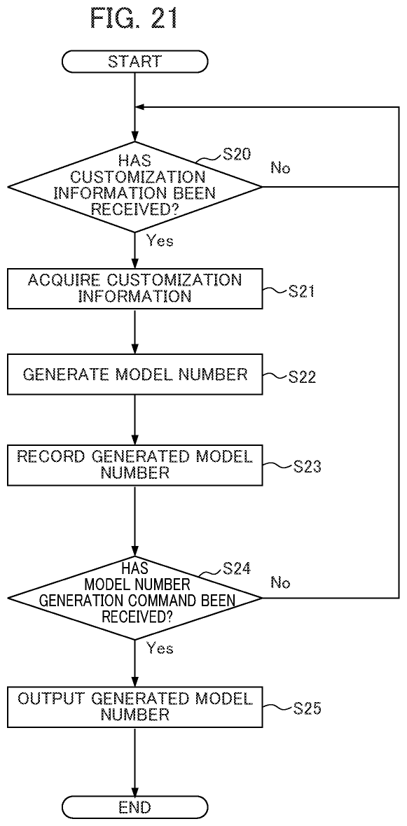

FIG. 21 is a flowchart showing a flow of the automatic model numbering processing executed by the management server 10 of FIG. 2 having the functional configuration of FIG. 3. The automatic model numbering processing starts when the processor 30 receives customization information from the user terminal 1.

First, the processor 30 determines whether the communication unit 17 has received customization information from the user terminal 1 (Step S20). When the communication unit 17 receives customization information from the user terminal 1 (Step S20: YES), the processor 30 acquires the customization information and reads the specification information included in the customization information (Step S21). Next, the processor 30 refers to the corresponding model number table in the storage unit 16, and specifies and generates a model number of the customized product based on the specification information (Step S22). The processor 30 stores the data in the customized product data base of the storage unit 16 (Step S23).

The processor 30 determines whether the communication unit 17 has received a model number generation command from the user terminal 1 (Step S24). The model number generation command is transmitted after the user terminal 1 transmits all of the customization information. The management server 10 reads a model number for various specifications generated from the customized product database of the storage unit 16 upon reception of the model number generation command, and outputs the entire model number as a customized product to the user terminal 1.

If the communication unit 17 has not received a model number generation command from the user terminal 1 (Step S24: NO), the processor 30 shifts the processing to Step S20. If the communication unit 17 has received a model number generation command from the user terminal 1 (step S24: YES), the processor 30 reads a model number for various specifications generated from the customized product database of the storage unit 16, transmits the entire model number as the customized product to the user terminal 1 via the communication unit 17 together with the information for generating a product display screen (Step S25), and ends the processing.

In the product display system S according to the present embodiment, it is possible to display the customized product based on the generated model number. Furthermore, the management server 10 according to the present embodiment can change and highlight display of an existing product or a product specified based on the customization information in the product display screen. In other words, the processor 30 of the management server 10 displays at least one selected from the plurality of existing products and a customized product on the screen of the output unit 45 of the user terminal 1 so as to be able to recognize the relationship between the existing products and the customized product based on the model numbers of the existing products and the model number of the customized product.

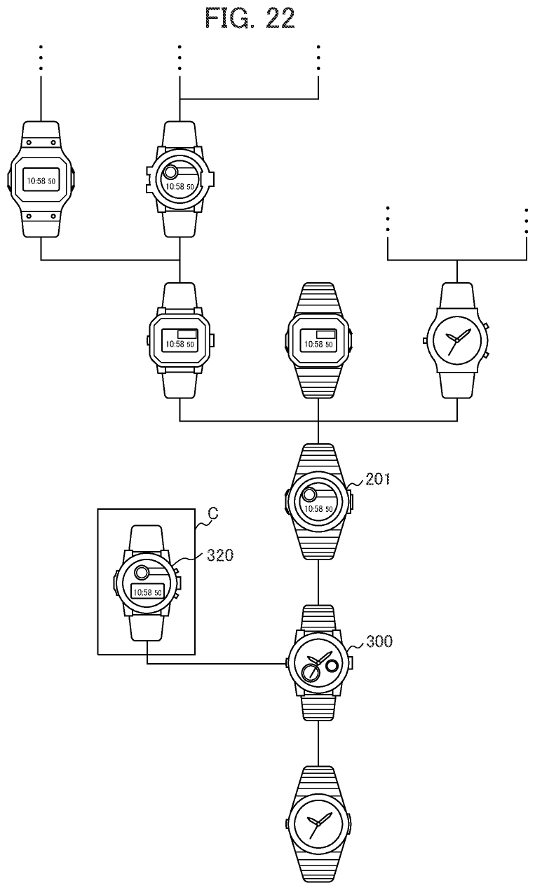

For example, when a customized product C is added in the product display screen shown in FIG. 7, in the product display system S, the product image 320 of the customized product is displayed based on the model number generated as shown in FIG. 22, and is surrounded by a thick frame C for emphasis. In this case, the tree display screen of FIG. 22 is a mode of a product display screen that allow recognition of the relationship between a plurality of products and a customized product. Furthermore, the highlighting method may include a method of changing display of the product image 320 itself. For example, the highlighting method may change the size and color of the product image 320 or may be a movement animation.

Furthermore, the product display screen according to the present embodiment changes only display of a product image of a customized product as a mode that allow recognition of the relationship between a plurality of products and a customized product of the user. However, the present disclosure is not limited to this. For example, the product display screen may allow recognition of the relationship between the plurality of products and the customized product in a distinguishable manner by changing only display of product images of the plurality of products other than the customized product, or may allow recognition of the relationship between the plurality of products and the customized product in a distinguishable manner by changing display of both the customized product and existing products. Furthermore, the mode of the product display screen that allow recognition of the relationship between the plurality of products and the customized product is not limited to the tree display screen, and may be, for example, a sort display screen.

Here, the display unit is a screen of the output unit 45 of the user terminal 1 in the present embodiment. However, the present disclosure is not limited to this, and the display unit may be a screen of the output unit 15 of the management server 10. Furthermore, the processing for displaying on the display unit may be processing of generating a screen of the mode displayed on the screen of the output unit 45 of the user terminal 1, or processing of generating possession information or product information for generating a screen of the mode by the user terminal 1.

That is, the processor 30 of the management server 10 according to the present embodiment determines the position of each image of a plurality of existing products displayed in a list based on a model number set for each of the plurality of existing products, and determines the position of an image of a customized product in which the existing product is customized based on the model numbers of the existing products and customized products. Specific processing will be described below.

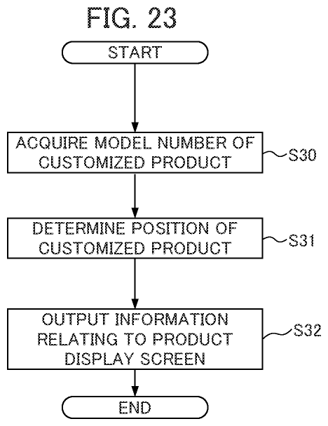

FIG. 23 is a flowchart showing a flow of customized product displaying processing executed by the management server 10 of FIG. 2 having the functional configuration of FIG. 3. The customized product displaying processing starts at a timing when the processor 30 receives a request for a product display screen while a model number is stored in a customized product database of the storage unit 16.

First, the processor 30 acquires a model number stored in the database from a customized product database of the storage unit 16 (Step S30). Next, the processor 30 determines the position of each image of the plurality of existing products displayed in the list based on model numbers of the products set for each of the plurality of existing products, and determines the position of the image of a customized product in which the existing product is customized based on model numbers of the existing products and the model number of the customized product (Step S31).

Here, an example of specific processing for determining the position of the customized product images will be described. First, the processor 30 compares the product information of the customized product with the product information of the existing products for the brand as the product information of the highest hierarchical level in the tree structure, and searches for an existing product that matches the customized product. When the search is completed, the processor 30 compares the product information of the customized product with the product information of the existing product of the same brand as the customized product for the sub brand as the product information of one lower hierarchical level, and searches for an existing product that matches the customized product. By repeating the above processing, the position of the image of the customized product is determined to be one position behind the position of the closest product. However, the method of determining the position of the customized product images is not limited to this.

Next, the processor 30 instructs the communication control section 31 to transmit determined positional information of the image for each of the plurality of existing products, information of the position of the image of the customized product, and information for a product display screen such as image information, to the user terminal 1 via the communication unit 17 (Step S32). In the user terminal 1 that has received the information, a product display screen in which the customized product is displayed by a dedicated application program is generated and displayed on a screen of the output unit 45 of the user terminal 1. In Step S32, the processor 30 may generate a screen of the product display screen on which the customized product is displayed, and transmit the screen to the user terminal 1.

The management server 10 configured as described above includes the processor 30 configured to acquire the customization information indicating a specification of a customized product whose specification is set by a user, and generate a model number of the customized product in which the specification of the customized product is based on the customization information.

With such a configuration, it is possible for the management server 10 according to the present embodiment to easily generate a model number that reflects the specification of the customized product whose specification is set by the user.

In the management server 10 according to the present embodiment, the specification of the customized product is set by changing the specification of the existing product, and the processor 30 acquires customization information indicating the specification of the customized product in which the specification of the existing product is changed.

With such a configuration, it is possible for the user to set the specification of the customized product based on the specifications of the existing products, and thus it is possible to more easily set the specification of the customized product.

Furthermore, the processor 30 of the management server 10 according to the present embodiment generates a model number of a customized product based on a model number set based on the specification of the existing product and customization information.

Thus, in the management server 10 according to the present embodiment, it is possible to generate a model number of the customized product based on the model number of the existing product, and thus it is possible to set the specification of the customized product.

In the management server 10 according to the present embodiment, the processor 30 acquires the customization information generated based on the specification of the customized product selected by the user from the user terminal 1.

With such a configuration, the user can generate the model number of the customized product by transmitting the customization information to the management server 10 through the user terminal 1 without directly working on the management server 10, thereby improving the convenience.

In the management server 10 according to the present embodiment, the processor 30 acquires the customization information including information related to products other than specifications, and generates a model number of a customized product in which information including the related information is reflected.

With such a configuration, in the management server 10, the processor 30 can generate a model number of the customized product in which the specification change of the customized product having a higher degree of freedom is reflected. Therefore, in the management server 10, customization with a higher degree of freedom becomes feasible, and the user can become more attached to the customized product that the user creates.

Furthermore, in the management server 10 according to the present embodiment, the processor 30 performs processing of displaying at least one selected from the existing product and the customized product on the screen of the output unit 45, and when displaying on the screen of the output unit 45, determines the position of display of the existing product based on the model number set in the plurality of existing products, and determines the display position of the customized product based on the model number of the customized product.

With such a configuration, it is possible for the user to know the position of the customized product created by the user, in the product lineup, and have more attachment thereto.

Furthermore, in the management server 10 according to the present embodiment, the processor 30 displays at least one selected from the existing product and the customized product on the screen of the output unit 45 so that the relationship between the existing product and the customized product can be recognized based on the model number of the existing product and the model number of the customized product.

With such a configuration, it is possible for the user to more easily recognize the customized product displayed together with the existing products.

### Modified Example

It should be noted that the present disclosure is not limited to the above-described embodiments, and variations, improvements, and the like within a scope capable of achieving the objects of the present disclosure are included in the present disclosure.

In the product display system S according to the present embodiment, the management server 10 transmits the product display screen to the user terminal 1 by performing processing of generating a product display screen when receiving a command of the product display screen transmitted from the user terminal 1. However, the present disclosure is not limited to this. For example, the management server 10 may perform processing of transmitting information necessary for generating a product display screen such as product information to the user terminal 1 when receiving a command for generating a product display screen transmitted from the user terminal 1, and generating a product display screen at the user terminal 1.

Furthermore, the product display screen generated by the processor 30 of the management server 10 according to the present embodiment displays all of the products stored in the product data base of the storage unit 16. However, the present disclosure is not limited to this, and the contents of the product display screen to be displayed may be changed according to the set condition. For example, when outputting a product display screen to users having the number of registrations of possession information that is equal to or greater than a predetermined number, the processor 30 may add additional data to the product display screen to be outputted. Furthermore, when outputting a product display screen to users having the number of registrations of possession information that is less than a predetermined number, the processor 30 may display only a part of the products stored in the product database. In addition, the processor 30 may perform processing of generating a product display screen such as a tree display screen only for specified products.

Furthermore, in the product display system S according to the present exemplary embodiment, the possession information is inputted by the user directly by the input operation to the keyboard or the like of the input unit 44 of the user terminal 1. However, the present disclosure is not limited to this. For example, the possession information may be acquired from image information of an image captured by the image capturing unit 48 of the user terminal 1 capturing a two-dimensional bar code or a three-dimensional bar code displayed on the product. Furthermore, the possession information may be acquired using learning models learned by machine learning or the like from the image information of the captured product by imaging the product with the image capturing unit 48. Furthermore, the possession information may be acquired from an IC-tag or the like provided in the product by NFC communication by the short range communication unit 49 of the user terminal 1.

The processing sequence described above can be executed by hardware, and can also be executed by software. In other words, the functional configuration of FIGS. 3 and 5 is merely an illustrative example, and the present invention is not particularly limited thereto. More specifically, the types of functional blocks employed to realize the above-described functions are not particularly limited to the examples shown in FIGS. 3 and 5, so long as the management server 10 can be provided with the functions enabling the aforementioned processing sequence to be executed in its entirety.

In addition, a single functional block may be configured by a single piece of hardware, a single installation of software, or a combination thereof. The functional configurations of the present embodiment are realized by a processor executing arithmetic processing, and processors that can be used for the present embodiment include a unit configured by a single unit of a variety of single processing devices such as a single processor, multi-processor, multi-core processor, etc., and a unit in which the variety of processing devices are combined with a processing circuit such as ASIC (Application Specific Integrated Circuit) or FPGA (Field-Programmable Gate Array).

In the case of having the series of processing executed by software, the program constituting this software is installed from a network or recording medium to a computer or the like. The computer may be a computer equipped with dedicated hardware. In addition, the computer may be a computer capable of executing various functions, e.g., a general purpose personal computer, by installing various programs.

The storage medium containing such a program can not only be constituted by the removable medium distributed separately from the device main body for supplying the program to a user, but also can be constituted by a storage medium or the like supplied to the user in a state incorporated in the device main body in advance. The removable medium is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance is constituted by, for example, the ROM 12 of FIG. 2 in which the program is recorded or a hard disk included in the storage unit 16 of FIG. 2 or 5, etc.

It should be noted that, in the present specification, the steps defining the program recorded in the storage medium include not only the processing executed in a time series following this order, but also processing executed in parallel or individually, which is not necessarily executed in a time series.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

What is claimed is:

1. An information processing apparatus comprising a processor configured to execute processing comprising:
acquiring possession information indicating a product in possession owned by a user;
specifying, among a plurality of products, the product in possession of the user corresponding to the possession information; and
causing a display unit to display at least one selected from information relating to the plurality of products and information relating to the product in possession of the user that is specified, in a manner that allow recognition of a relationship between the plurality of products and the product in possession of the user that is specified.

2. The information processing apparatus according to claim 1, wherein the processor is further configured to execute processing comprising:
acquiring customization information indicating a specification of a customized product for which the specification is set by a user;
generating customized product identification information in which the specification of the customized product is based on the customization information; and
causing a display unit to display, in a recognizable manner, a relationship between the plurality of products and the customized product according to the customized product identification information that is generated by the generating.

3. The information processing apparatus according to claim 2, wherein
the specification of the customized product is set by changing a specification of an existing product, and
the processor is further configured to execute processing comprising acquiring the customization information indicating the specification of the customized product generated by changing the specification of the existing product.

4. The information processing apparatus according to claim 1, wherein
respective pieces of information relating to the products includes a plurality of pieces of information relating to specifications of each of the products, and
the processor is further configured to execute processing comprising determining an arrangement of the plurality of products displayed based on a specification designated from among the plurality of pieces of information relating to specifications of each of the products.

5. The information processing apparatus according to claim 1, wherein
respective pieces of information relating to the products includes a plurality of pieces of information relating to specifications of each of the products, and
the processor is further configured to execute processing comprising generating a system diagram of the plurality of products based on the information relating to the products.

6. The information processing apparatus according to claim 2, wherein
respective pieces of information relating to the products includes a plurality of pieces of information relating to specifications of each of the products, and
the processor is further configured to execute processing comprising generating a system diagram of the plurality of products based on the information relating to the products.

7. The information processing apparatus according to claim 3, wherein
respective pieces of information relating to the products includes a plurality of pieces of information relating to specifications of each of the products, and
the processor is further configured to execute processing comprising generating a system diagram of the plurality of products based on the information relating to the products.

8. The information processing apparatus according to claim 5, wherein the processor is further configured to execute processing comprising setting text information to be displayed between products in the system diagram.

9. The information processing apparatus according to claim 6, wherein the processor is further configured to execute processing comprising setting text information to be displayed between products in the system diagram.

10. The information processing apparatus according to claim 1, wherein
respective pieces of information relating to the products includes a first identifier indicating a sub brand associated with a predetermined brand, and
the processor is further configured to execute processing comprising generating information relating to display in which the plurality of products are divided for each sub brand based on the information relating to the first identifier.

11. The information processing apparatus according to claim 10, wherein
respective pieces of information relating to the products includes a second identifier indicating a series associated with the sub brand, and
the processor is further configured to execute processing comprising generating information relating to display in which the plurality of products are divided for each series based on the information relating to the second identifier.

12. The information processing apparatus according to claim 11, wherein
respective pieces of information relating to the products includes a third identifier indicating a successor model of product associated with the series, and
the processor is further configured to execute processing comprising generating information relating to display indicating a state linking the successor model after the product associated with the series based on the information relating to the product including the third identifier.

13. The information processing apparatus according to claim 1, wherein the processor is further configured to execute processing comprising setting an appearance image of the product corresponding to the product in possession among the plurality of products to an appearance image that matches a specification of the possession information.

14. The information processing apparatus according to claim 1, wherein the processor is further configured to execute processing comprising shifting to sales processing for purchasing the product in a case in which a purchase target product is designated from among the plurality of products displayed in a list.

15. The information processing apparatus according to claim 1, wherein the processor is further configured to execute processing comprising at least one selected from acquiring the possession information based on information manually inputted by a user, acquiring the possession information by an imaging unit reading an identifier, acquiring the possession information by receiving information from an external device by short-range radio communication, and acquiring the possession information by analyzing an image of the product in possession image-captured by the imaging unit.

16. An information processing system comprising:
an electronic apparatus including a first communication unit that can transmit possession information indicating a product in possession owned by a user to an external device; and
an information processing apparatus including a second communication unit and a processor, the second communication unit being configured to communicate with the first communication unit to acquire the possession information, the processor being configured to execute processing comprising specifying the product in possession of the user corresponding to the possession information among a plurality of products, and causing a display unit to display at least one selected from information relating to the plurality of products and information relating to the product in possession of the user that is specified, in a manner that allow recognition of a relationship between the plurality of products and the product in possession of the user that is specified.

17. A non-transitory computer-readable storage medium storing a program that is executed by a computer that comprises a processor to control an information processing apparatus, the program being executable to cause the computer to perform operations comprising:
acquiring possession information indicating a product in possession owned by a user;
specifying, among a plurality of products, the product in possession of the user corresponding to the possession information; and
causing a display unit to display at least one selected from information relating to the plurality of products and information relating to the product in possession of the user that is specified, in a manner that allow recognition of a relationship between the plurality of products and the product in possession of the user that is specified.

18. A product display method executed by an information processing apparatus, the method comprising:
acquiring possession information indicating a product in possession owned by a user;
specifying, among a plurality of products, the product in possession of the user corresponding to the possession information; and
causing a display unit to display at least one selected from information relating to the plurality of products and information relating to the product in possession of the user that is specified, in a manner that allow recognition of a relationship between the plurality of products and the product in possession of the user that is specified.

19. The product display method according to claim 18, further comprising:
acquiring customization information indicating a specification of a customized product for which the specification is set by a user;
generating customized product identification information for which the specification of the customized product is based on the customization information; and
causing a display unit to display, in a recognizable manner, a relationship between the plurality of products and the customized product according to the customized product identification information that is generated by the generating.

20. The product display method according to claim 19, wherein
the specification of the customized product is set by changing a specification of an existing product, and
the method further comprises acquiring the customization information indicating the specification of the customized product generated by changing the specification of the existing product.
